(19) United States
(12) Patent Application Publication
(10) Pub. No.: US 2023/0250690 A1
(43) Pub. Date: Aug. 10, 2023

(54) ADJUSTABLE VALANCE SYSTEM

(71) Applicant: Noble Interiors Inc., St. Albert (CA)

(72) Inventor: Wendy Noble, St. Albert (CA)

(21) Appl. No.: 17/669,006

(22) Filed: Feb. 10, 2022

(30) Foreign Application Priority Data
Jan. 18, 2022 (CA) 3145946

(51) Int. Cl. E06B 9/323; E06B 9/262

(52) U.S. Cl. CPC E06B 9/323; E06B 9/262

(57) ABSTRACT

A valance system that is reusable, updateable, and easy to install has a telescoping headrail and clips to removably attach a window treatment to the headrail. Clip slots on the telescoping headrail attach to the clips allowing multiple valance styles to be created. The clips may be ironed onto the window treatment or sewn on. The valance system may have a pulley system for attaching blinds or shades, and a motor for motorized blinds. The valance system may be installed by positioning the headrail above a window or opening, telescoping the headrail to the desired width and mounting it to a supporting structure and attaching the clips to the window treatment and to the headrail. The headrail may later be removed and attached to a different supporting structure. The window treatment may be updated by removing the window treatment from the headrail and attaching a different window treatment.

### PRIORITY CLAIM

This application claims priority from Canada Patent Application No. 3145946, filed Jan. 18, 2022, entitled ADJUSTABLE VALANCE SYSTEM, the contents of which is incorporated herein by reference.

### FIELD OF THE INVENTION

This application relates generally to window treatments, and more particularly to adjustable and re-mountable valances.

### BACKGROUND OF THE INVENTION

High quality window treatments are usually custom made. A window treatment may include a valance to hide the curtain or blind hardware for a professional and well decorated look. Traditional valances involve fabric stapled to a custom wooden headrail and can involve elaborate systems to create different styles. The conventional method typically requires the valance to be attached to the headrail in a permanent fashion. Once installed the valances are not easily modified, and due to the high cost of conventional equipment, valances are often passed over by otherwise interested users. There is a need for a simple and inexpensive valance system that can be easily adjusted, removed, re-mounted and updated as desired.

### SUMMARY OF THE INVENTION

There is provided an adjustable valance system having an elongated telescoping headrail comprising two extending sections, the two extending sections being telescopically movable relative to each other, the headrail comprising mounts to mount the headrail to a supporting structure and clips configured to attach to a window treatment and to removably engage with the headrail.

There is also provided a clip for removably attaching to a valance headrail, the clip having two parallel faces and a connector extending between the two parallel faces.

In various embodiments, there may be included any one or more of the following features: the telescoping headrail further comprises an inner section and the two extending sections further comprise two outer sections, and the inner section slidably engages with the two outer sections; the clips have two parallel faces and engage with the headrail by sliding into slots on a front surface of the headrail so one of the parallel faces is in front of the front surface and the other parallel face is behind the front surface; the slots are spaced 2 inches apart; the slots are positioned along the top of the front surface; the clips are sewn into the window treatment; the clips are ironed onto the window treatment; the mounts further comprising brackets slidably and removably attached to the headrail; a pulley system attached to the telescoping headrail for attaching to a blind; a motor configured to raise and lower a blind; the connector being generally perpendicular to the two parallel faces.

There is also provided a method of installing an adjustable valance: providing an adjustable valance, the adjustable valance comprising an elongated telescoping headrail comprising two extending sections, the two extending sections being telescopically movable relative to each other and each of the two extending sections comprising mounts to mount the headrail to a supporting structure, adjusting the two extending sections based on the size of window for receiving a window treatment, mounting the adjustable valance to the supporting structure above the window using the mounts, connecting clips to the window treatment, and attaching the clips to the headrail to connect the window treatment to the headrail.

In various embodiments, there may be included any one or more of the following features: removing the clips from the headrail, removing the adjustable valance from the supporting structure, adjusting the size of the adjustable valance by adjusting a telescopic position of the two extending sections relative to each other in order to fit a differently-sized window, and mounting the adjustable valance to a supporting structure above the differently-sized window; attaching the clips to the headrail to connect the window treatment to the headrail; providing a differently-sized window treatment for the differently-sized window and connecting the clips or other clips to the differently-sized window treatment, and attaching the clips or other clips to the headrail to connect the differently-sized window treatment to the headrail; removing the clips from the headrail, attaching the clips to the headrail in a different configuration to form a different window treatment appearance; removing the clips from the headrail, connecting other clips to another window treatment, attaching the other clips to the headrail to connect the other window treatment to the headrail.

These and other aspects of the device and method are set out in the claims.

### BRIEF DESCRIPTION OF THE DRAWINGS

Embodiments will now be described with reference to the figures, in which like reference characters denote like elements, by way of example, and in which:

FIG. 1 shows a top perspective view of a telescoping headrail for a valance system in an elongated position.

FIG. 2 shows a bottom perspective view of the telescoping headrail of FIG. 1 in a partially retracted position.

FIG. 3 shows a back, bottom perspective view of part of a telescoping headrail for a valance system configured with a pulley system.

FIG. 4 shows a back, bottom perspective view of part of a telescoping headrail for a valance system configured with a motorized blind or shade.

FIGS. 5A and 5B show two embodiments of a clip for attaching a window treatment to a headrail for a valance system.

FIG. 6 shows a top view of a valance attached to a telescoping headrail in an elongated position.

FIG. 7 shows a top view of a valance attached to a telescoping headrail in a retracted position.

FIGS. 8A and 8B show back views of two embodiments of a valance with clips secured to the valance.

FIG. 9 shows a pin for attaching to the window treatment to create various decorative window treatment styles.

FIG. 10 shows an example embodiment of a pattern for a window treatment.

### DETAILED DESCRIPTION OF THE PREFERRED EMBODIMENT

Immaterial modifications may be made to the embodiments described here without departing from what is covered by the claims.

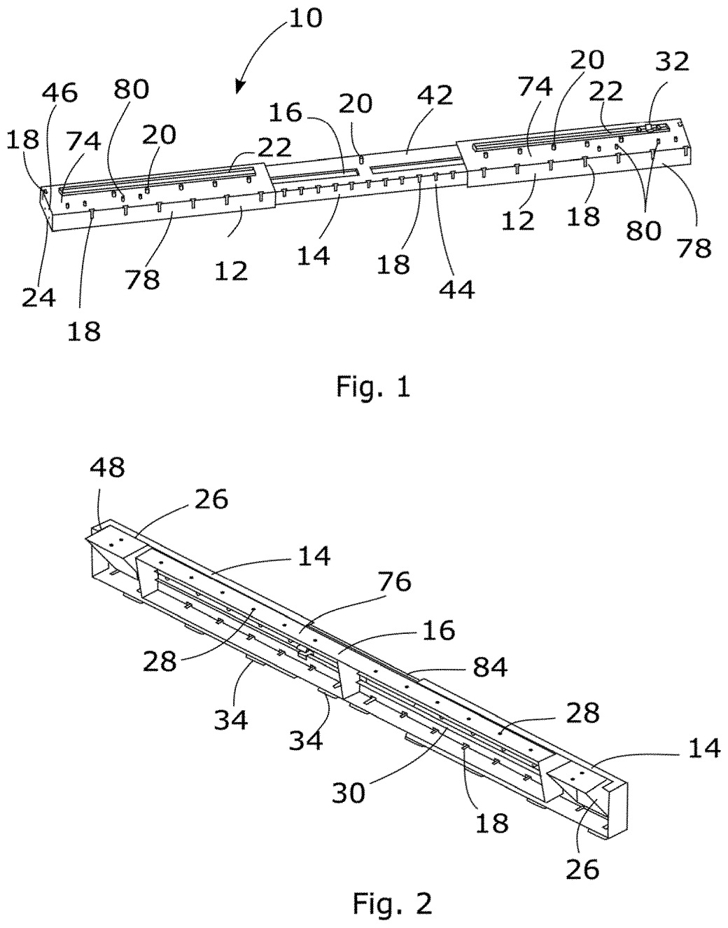

FIGS. 1 and 2 show an embodiment of an elongated telescoping headrail 10 for an adjustable valance system that is reusable and easy to install. The telescoping headrail 10 supports a window treatment and attaches securely to a vertical or horizontal supporting structure, for example a wall or ceiling or other supporting structure above a window or opening. The telescoping headrail 10 may be generally rectangular with a generally rectangular or square cross section. Telescoping headrail 10 has two or more extending sections, the extending sections being telescopically movable relative to each other. The extending sections may be formed so an inner section engages with an outer section and the inner and outer sections are telescopically movable relative to each other. The extending sections may be two outer sections 12 which slidably engage with an inner section 14 within the outer sections. Inner section 14 may have a indented track 84 at the top of a back surface of the inner section to allow the outer section to engage with the inner section so the back surfaces of the inner section and outer section are flush with each other. Tabs 30 on an outer section 12 may extend into tracks 16 formed in the inner section, for example on a top surface 42 of the inner section. The tabs 30 may have a catch at the ends of the tabs 30 which extends over a side of the track 16 to securely hold the inner and outer section together while allowing the inner and outer section to slide relative to each other to adjust the width of the telescoping headrail.

The telescoping headrail may be configured to be adjustable to lengths appropriate to cover typical window widths. For example, the telescoping headrail may be configured to be adjustable between 27 and 50 inches in length, or between 55 and 100 inches in length, or between 79 and 124 inches in length. One or more headrails may be mounted side by side.

The telescoping headrail may be side-mounted, end-mounted or ceiling mounted using mounts on the headrail. The mounts may be holes provided on a top surface, end surfaces or back surface of the headrail 10. For example, holes 20 may be provided on the top surfaces 42 and 74 of the inner section 14, the outer sections 12 or both, to allow the headrail 10 to be screwed into a ceiling, holes 24 on the end surfaces 46 of the extending sections to allow the headrail to be end-mounted, and holes 28 along the back surface of the extending sections, for example back surface 76 on the inner section, to allow the headrail to be wall-mounted. Each inner and outer surface may have mounts on the top surface, back surface or end surfaces as applicable in the headrail configuration. Holes 20 on the outer sections may be aligned with track 16 on the inner section, so the holes are accessible at each telescopic position.

The mounts may further be brackets 26 attached to the telescoping headrail, as shown in FIG. 2. Brackets 26 may have a generally triangular cross section and may have holes 48 along a back surface of the bracket 26 for receiving screws. The brackets 26 may extend into a track 22 formed on the top surfaces 42 and/or 74 of the headrail 10 that allows the brackets to slide side to side on the headrail while attached to the headrail, allowing the brackets to be easily positioned for mounting the telescoping headrail. The brackets may extend into the track using tabs 32 on a top surface of the brackets, the tabs holding the brackets securely on the headrail. For example, two tabs may have a width approximately the width of the track from front to back to hold the brackets in place, and third tab may have a catch at the end of the tab, which when in place extends over a top edge of the track to prevent the bracket from falling out of the headrail. The brackets 26 may be mounted below the headrail so the brackets are hidden by the headrail and window treatment when the valance system is installed. Additional central brackets may be added along the headrail to support heavier materials or window treatments.

The window treatment may be any known window treatment, for example a valance, roller blind, or roman shade or a combination of window treatments, an exemplary roman blind is shown in FIG. 4. The window treatment may be supplied with the valance system or added separately by the user.

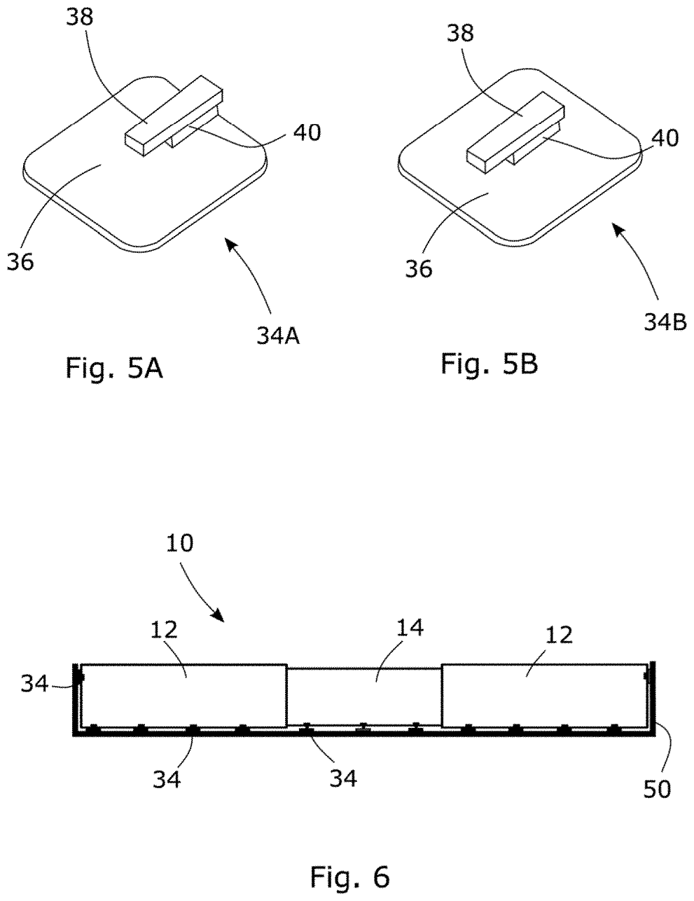

The window treatment is connected to the headrail 10 in a removable manner. The window treatment may be attached to the headrail using clips 34. Two exemplary embodiments of clips 34 (34A and 34B) are shown in FIGS. 5A and 5B. The clips 34 are configured to attach to the valance or window treatment and are configured to removably attach to the headrail. The clips may be attached to the window treatment in a variety of ways, for example by being sewn on or into the window treatment, or hot glued or ironed onto the window treatment. The clips 34 are preferably attached near the top of the window treatment but may be positioned by the user at any height along the window treatment to achieve their desired appearance.

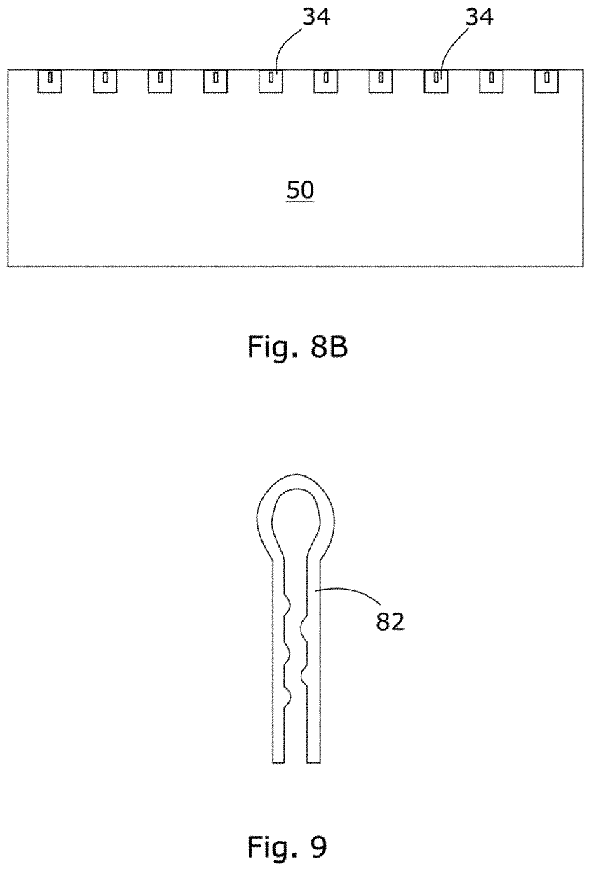

As shown in the embodiment in FIG. 8A, the clips 34 may be ironed onto the window treatment, such as a valance 50, using a ribbon or band 64 attached to the clips with a glue backing. The ribbon or band 64 may string multiple clips together, and may be pre-attached to the clips. As shown in the embodiment in FIG. 8B, the clips 34 may be attached to the window treatment directly. FIGS. 8A and 8B show two examples of where the clips may be placed relative to a top edge of the window treatment to achieve different appearances when installed. The window treatment may also be attached to the headrail using other known methods.

The clips 34 may have two parallel tabs, 36 and 38, connected by a connector piece 40 generally perpendicular to both tabs, as shown in the embodiments in FIGS. 5A and 5B. Tab 38 and connector 40 may be positioned at the top of tab 36, as shown in the embodiment in FIG. 5A, or may be positioned more centrally on tab 36, as shown in the embodiment in FIG. 5B. Tab 36 attaches to the window treatment as described above. Tab 36 may be removably attached to the window treatment. The clips removably attach to the headrail 10, for example by engaging with corresponding clip slots 18 on the headrail 10. Clips 34 may slide into clip slots 18 so tab 38 is positioned behind front surfaces 44 and 78 of the extending sections of the headrail 10 and tab 36 is positioned in front of the front surfaces 44 and 78, with the connector piece 40 extending through the clip slot 18. Clip slots 18 may be on the front surfaces 44 and/or 78 of all extending sections and extend partially over the top surfaces 42 and/or 74 of all extending sections to allow for easy insertion of the clips. The clip slots 18 are preferably positioned on each extending section so the clips and/or the window treatment are all at the same height relative to the window or opening when the window treatment is installed on the headrail, and may extend from the top of the front surfaces to half or less than half the distance down the front surfaces. Additional clip slots 18 may be provided on the end surfaces 46 of the headrail 10 to allow the window treatment to wrap around the headrail 10. The clip slots may be equally spaced along the headrail from one end surface of the headrail to the other end surface of the headrail. The clip slots may for example be 2 inches apart from each other, or 50 mm apart or 25 mm apart. The distance between the slots may be different on the inner section and outer section of the headrail.

The clips 34 and clip slots 18 allow the positioning of the clips to be modified so the user can change the appearance of the window treatment or replace the window treatment with a different window treatment. The user may create a multitude of decorative styles in the window treatment, for example beauty pleats, reverse pleats or ripple fold pleats by adjusting the size of the headrail, the placement of the clips in the clip slots, or the placement of the clips on the window treatment. The clips may be spaced evenly among the clip slots, or unevenly. The number of clips used may depend on the width of the fabric and the style chosen, for example the number of clips used could be in the range of 14 to 27 clips. The easy clip system means that each valance system can be updated with new fabrics or pleat styles, or even changed from a valance to a shade or blind without the need to completely remount the headrail. The clips on the system also mean that instead of entirely replacing a valance system, the window treatment can simply be updated.

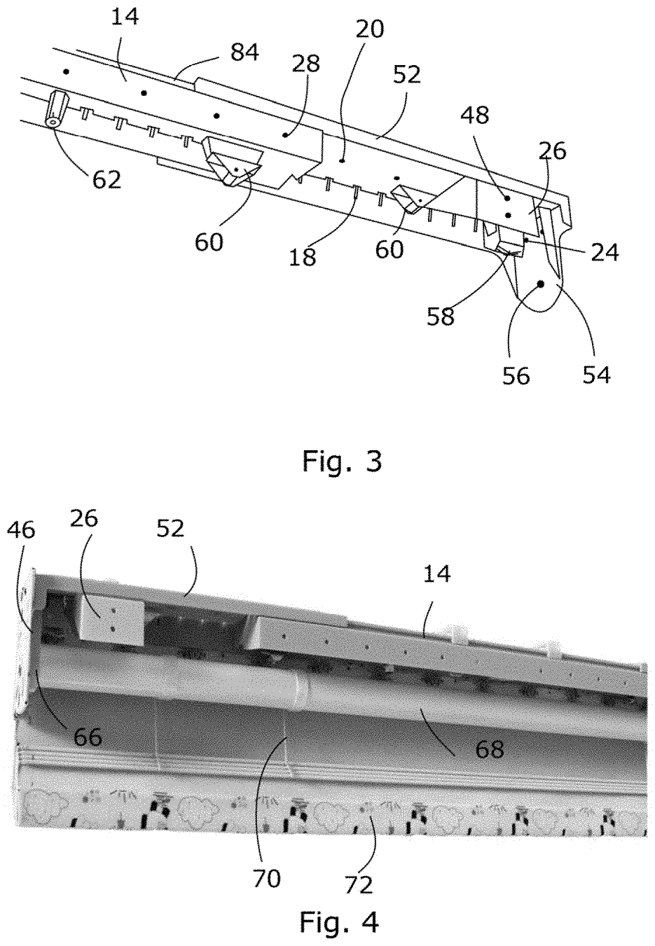

The headrail may be configured to support a blind or curtain, for example a roman shade or roller blind. An example configuration is shown in FIGS. 3 and 4. The blind or curtain may have a built-in valance to cover the headrail, or may be attached to the headrail in addition to a separate valance. The headrail may support a pulley system comprised of parts 58, 60, 62 and cords (not shown) which are suspended through the pulley system and attach to the blinds or shades to raise and lower the blinds or shades. The pulley system may be any known pulley system for blinds or shades. Pulley and cord lock 58 may be positioned at either end of the headrail, with dowels 60 placed along the headrail to position the cords. Outer section 52 is shown in the embodiments of FIGS. 3 and 4, but the pulley system may be used with other outer sections, for example outer section 12. Pulley holes 80 may be provided in top surfaces 42 and 74 to mount the pulley system parts. Pulley holes 80 may be placed at any point along the top surface.

As shown in the embodiment of FIG. 4, the blinds or shades may be motorized. By way of example only, the blinds may be motorizered using a blind motorization system from Somfy™. A tube 68 containing a motor or gear may be attached to the headrail 10. The tube 68 may attach to outer sections 52 which are configured to support the tube for example with hole 56 and ledge 66 on ends 54. The blind or shade cords 70 of the blind or shade 72 wrap or unwrap around the tube as the motor turns to raise and lower the blind or shade 72. The motor or gear may be run by an external battery pack or chargeable battery which may be secured into place on the headrail 10 by a bracket. The motor may be remotely controlled using a remote control or app.

The headrail may also be configured to support a curtain or blind rod to hang curtains or blinds. For example, outer sections 52 may support a curtain or blind rod.

To install the valance system a user may position the headrail 10 above a window or opening and telescope the headrail until it reaches the desired width based on the size of the window or opening. The user may then mount the headrail to the supporting structure using the mounts, for example with screws. The clips are connected to the window treatment, then attached to the headrail to connect the window treatment to the headrail. The clips may be attached to the headrail by slipping the clips into slots on the headrail. The user may create different window treatment appearances through different placements of the clips on the window treatment and the spacing of the slots chosen on the headrail to engage with the clips.

The valance system may be mounted inside a window, or interior or exterior to the window or opening.

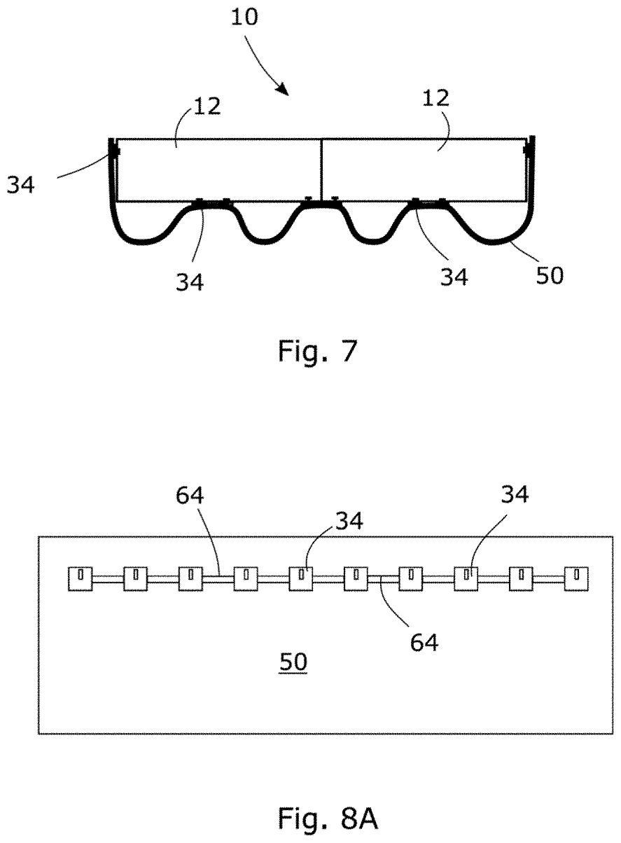

After installation, the user may remove or re-mount the adjustable valance system or replace the window treatment as desired. To re-mount the adjustable valance system the user may remove the clips from the headrail and remove the headrail from the supporting structure. The size of the headrail may then be adjusted by adjusting a telescopic position of the extending sections relative to each other, so the headrail fits a differently-sized window or opening. The headrail may then be mounted to a supporting structure above the differently-sized window or opening, and the same or different window treatment attached to the headrail using the clips. If using a different window treatment, for example a differently-sized window treatment, the user first attaches the clips or other clips to the window treatment, and then attaches the clips or other clips to the headrail to connect the different window treatment to the headrail. Even if the headrail size is adjusted to fit the size of a differently-sized window, it may be possible to use the same window treatment for the differently-sized window by changing the style of pleats in the window treatment, for example, as shown in FIGS. 6 and 7.

After installation the user may also update the window treatment by removing the window treatment, installed in an original configuration, from the headrail, attaching the clips or other clips to a different window treatment, and attaching the clips or other clips to the headrail to connect the different window treatment to the headrail. The user may alternatively update the window treatment by removing the window treatment from the headrail and attaching the clips to the headrail in a different configuration from the original configuration to form a different window treatment appearance.

FIGS. 6 and 7 show an embodiment of a valance 50 attached to the headrail 10 of an adjustable valance system in two positions. In FIG. 6, the headrail is in an elongated position and the valance 50 is flush against the headrail. In FIG. 7, the same valance 50 is attached to the headrail 10 in a retracted position and decorative pleats are applied to allow the same valance to be used for a differently-sized window or opening. The cooperation of the adjustable headrail and the valance in these embodiments allow for maximum flexibility in terms of modular use of the headrail and window treatments. A single headrail and window treatment can be used and re-used for various different shapes and styles of windows or other openings.

FIG. 9 shows an embodiment of a pin 82 which may be used to create and secure various decorative styles created in the window treatment. The pins may have two generally parallel arms that may be slipped over the top or an edge of the window treatment, with one arm on either side of the window treatment. The pins may be used to secure two or more sections of the window treatment together, for example to create a pleat, or may attach to the window treatment and engage with slots 18. To engage with slots 18 one or more of the pin arms may be configured to be able to slip into the slot 18, while the other pin arm remains in front of the headrail. The pins may be visible after installation of the window treatment, and therefore are preferably a color or material that will blend into the fabric, for example a clear plastic.

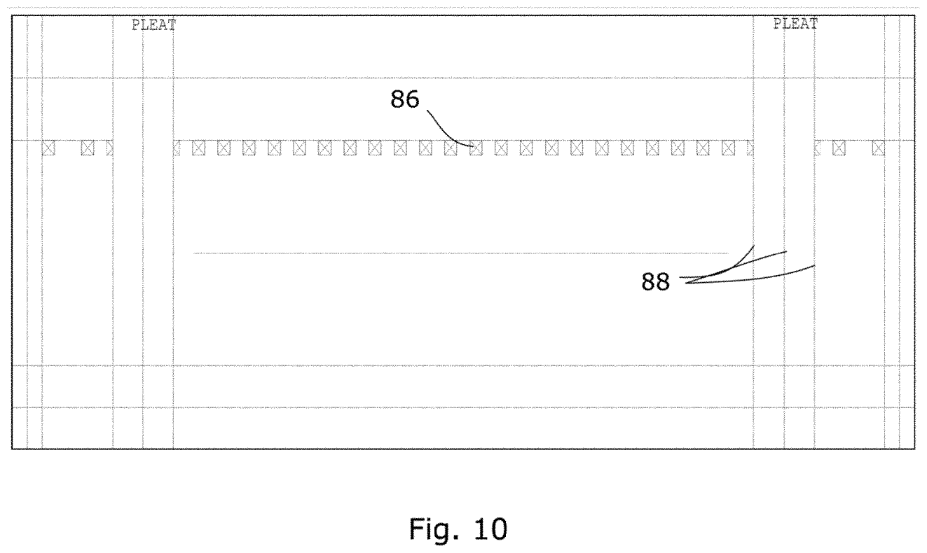

FIG. 10 shows an embodiment of a pattern that may be provided for a user to create their own window treatment for mounting on the headrail. The pattern shows an example of attachment points 86 for placement of clips 34, and an example of where to place a vertical pleat 88.

Embodiments of the telescoping headrail 10 and brackets 26 may be made out of lightweight and durable material, for example co-polymer polypropylene.

Embodiments of the valance system can be easily adjusted to fit any standard window, and can be removed, re-mounted, and updated as desired. It may create a professional look without the cost of professional installation and reduce waste because it can be easily transported and remounted.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

I claim:

1. An adjustable valance system, comprising:
an elongated telescoping headrail comprising two extending sections, the two extending sections being telescopically movable relative to each other, the headrail comprising mounts to mount the headrail to a supporting structure;
clips configured to attach to a window treatment and to removably engage with the headrail.

2. The adjustable valance system of claim 1 in which the telescoping headrail further comprises an inner section and the two extending sections further comprise two outer sections, and the inner section slidably engages with the two outer sections.

3. The adjustable valance system of claim 1 in which the clips have two parallel faces and engage with the headrail by sliding into slots on a front surface of the headrail so one of the parallel faces is in front of the front surface and the other parallel face is behind the front surface.

4. The adjustable valance system of claim 3 in which the slots are spaced 2 inches apart.

5. The adjustable valance system of claim 3 in which the slots are positioned along the top of the front surface.

6. The adjustable valance system of claim 1 in which the clips are sewn into the window treatment.

7. The adjustable valance system of claim 1 in which the clips are ironed onto the window treatment.

8. The adjustable valance system of claim 1 in which the mounts further comprising brackets slidably and removably attached to the headrail.

9. The adjustable valance system of claim 1 further comprising a pulley system attached to the telescoping headrail for attaching to a blind.

10. The adjustable valance system of claim 1 further comprising a motor configured to raise and lower a blind.

11. The adjustable valance system of claim 1 further comprising a pin configured to removably attach to the window treatment to hold decorative styles in place.

12. A clip for removably attaching to a valance headrail, the clip comprising two parallel faces and a connector extending between the two parallel faces.

13. The clip of claim 12 in which the connector is generally perpendicular to the two parallel faces.

14. A method of installing an adjustable valance, comprising:
providing an adjustable valance, the adjustable valance comprising an elongated telescoping headrail comprising two extending sections, the two extending sections being telescopically movable relative to each other and each of the two extending sections comprising mounts to mount the headrail to a supporting structure;
adjusting the two extending sections based on the size of window for receiving a window treatment;
mounting the adjustable valance to the supporting structure above the window using the mounts;
connecting clips to the window treatment; and
attaching the clips to the headrail to connect the window treatment to the headrail.

15. The method of claim 14 further comprising:
removing the clips from the headrail;
removing the adjustable valance from the supporting structure;
adjusting the size of the adjustable valance by adjusting a telescopic position of the two extending sections relative to each other in order to fit a differently-sized window; and
mounting the adjustable valance to a supporting structure above the differently-sized window.

16. The method of claim 15 further comprising attaching the clips to the headrail to connect the window treatment to the headrail.

17. The method of claim 15 further comprising providing a differently-sized window treatment for the differently-sized window and connecting the clips or other clips to the differently-sized window treatment, and attaching the clips or other clips to the headrail to connect the differently-sized window treatment to the headrail.

18. The method of claim 14 further comprising:
removing the clips from the headrail;
attaching the clips to the headrail in a different configuration to form a different window treatment appearance.

19. The method of claim 14 further comprising:
removing the clips from the headrail;
connecting other clips to another window treatment;
attaching the other clips to the headrail to connect the other window treatment to the headrail.
